(19) United States
(12) Patent Application Publication
(10) Pub. No.: US 2010/0037224 A1
(43) Pub. Date: Feb. 11, 2010

(54) APPLICATION PLATFORM

(75) Inventor: Yuichi Hosoda, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/511,453

(22) Filed: Jul. 29, 2009

(30) Foreign Application Priority Data
Aug. 5, 2008 (JP) 2008-201997

(51) Int. Cl. G06F 9/46; G06F 3/00

(52) U.S. Cl. 718/100; 710/18

(57) ABSTRACT

Activation and deactivation of multiple applications on a multi-function peripheral are more appropriately performed to enable users to comfortably use the multi-function peripheral at a workplace having various operating environments. At a time of a logout, control is performed to select and activate at least one of applications in a shutdown state, the selected application being likely to be used at the next login. Further, the number of applications being activated is limited to a predetermined number or less.

### BACKGROUND OF THE INVENTION

1. Field of the Invention

The present invention relates to an application platform for managing activation states of applications.

2. Description of the Related Art

Heretofore, a multi-function peripheral on which multiple applications can be installed has been proposed. Applications to be installed thereon include, for example, an application which lets users make a setting for a specific function through a user interface. Even if a large number of such applications are installed on a multi-function peripheral, the system resource limitations do not allow all the applications to be activated in parallel (not meaning that processes for activating the multiple applications cannot be performed, but meaning that multiple applications cannot be in a running state at the same time), and thus users cannot use all the applications simultaneously. In particular, an information storage unit of a multi-function peripheral often has a smaller storage size than those of so-called PCs and the like. Thus, it is a fact that a multi-function peripheral has more strict system resource limitation.

Japanese Patent Laid-Open No. 2007-279792 describes one method of solving the above-described problem. Specifically, according to the described method, applications to be activated in a multi-function peripheral are switched based on history information on past application use organized by time period. This method may be useful in the case where a certain application used in a certain time period (e.g., 10:00 to 12:00) in the past has a high possibility of being used again in the same time period. For example, the method may be useful in a workplace where a copy application and a FAX application are respectively used in the a.m. time period from 10:00 to 12:00 and the p.m. time period from 12:00 to 17:00 every day.

In reality, however, there are not so many cases where the same applications are used in the same time periods every day. From a different point of view, in the technology described in Japanese Patent Laid-Open No. 2007-279792, a needless activation or deactivation process is performed.

### SUMMARY OF THE INVENTION

An object of the present invention is to more appropriately perform activation and deactivation of multiple applications installed on a multi-function peripheral having more strict resource limitations and thus to enable users to comfortably use the multi-function peripheral at a workplace having various operating environments.

An application platform of the present invention comprises: a user interface configured to receive an instruction of a user; an application selecting component configured to select one or more applications to be brought into a running state, at a time of a logout of the user instructed through the user interface; an activation candidate setting component configured to set, as an activation candidate, an application in a shutdown state out of the applications selected by the application selecting component; an activation process component configured to activate an application; and a controller configured to cause, at the time of the logout, the activation process component to activate the application set as the activation candidate by the activation candidate setting component.

Alternatively, the application platform of the present invention comprises: a user interface configured to receive an instruction of a user; an application selecting component configured to select one or more applications to be brought into a running state, at a time of a login of the user through the user interface; a deactivation candidate setting component configured to set, as a deactivation candidate, an application in the running state out of the applications not selected by the application selecting component; a deactivation process component configured to perform a deactivation process on an application; and a controller configured to cause, at the time of the login, the deactivation process component to perform the deactivation process on the application set as the deactivation candidate by the deactivation candidate setting component.

A method of the present invention of managing an application platform on which a plurality of applications operate comprises the steps of: receiving an instruction of a user through a user interface; selecting one or more applications at a time of a logout of the user instructed through the user interface, the one or more applications to be brought into a running state; setting, as an activation candidate, an application in a shutdown state out of the applications selected in the application selecting step; activating an application; and controlling to cause an activating the application in the activating step, at the time of the logout, the application set as the activation candidate in the activation candidate setting step.

Alternatively, the method of the present invention comprises the steps of: receiving an instruction of a user through a user interface; selecting one or more applications to be brought into a running state, at a time of a login of the user through the user interface; setting, as a deactivation candidate, an application in the running state out of the applications not selected in the application selecting step; deactivating an application; and controlling to cause a deactivating the application in the deactivating step, at the time of the login, the application set as the deactivation candidate in the deactivation candidate setting step.

The present invention makes it possible to appropriately perform activation and deactivation of multiple applications installed on a multi-function peripheral without giving a stress to users who use the multi-function peripheral.

Further features of the present invention will become apparent from the following description of exemplary embodiments (with reference to the attached drawings).

### BRIEF DESCRIPTION OF THE DRAWINGS

FIG. 1 is a block diagram showing a configuration of an image forming apparatus to which an application platform of the present invention is applied;

FIG. 2 shows an example of an initial screen which is displayed when a user is logged into an image forming apparatus 1;

FIG. 3 shows an example of a screen which is displayed on a display of a user interface 124 when an instruction of a user is accepted, in a copy application;

FIG. 4 is a state chart showing transition of the state of an application;

FIG. 5 shows an example of an application management table;

FIG. 6 shows an example of a user-specific initial screen;

FIG. 7 is a diagram showing the correspondence of customizedly registered buttons and applications;

FIG. 8 shows an example of a customized button management table;

FIG. 9 shows an example of a message screen;

FIG. 10 shows an example of a screen which is used by a user to give the image forming apparatus 1 an instruction to switch display settings;

FIG. 11 shows an example of a screen in which the states of applications are displayed respectively on buttons indicating the applications on the initial screen;

FIG. 12 shows an example of a screen in which the states of applications are displayed respectively on buttons indicating the applications on the user-specific initial screen;

FIG. 13 shows an example of a screen in which the states of applications are displayed respectively on the buttons indicating the applications on the user-specific initial screen;

FIG. 14 is a flowchart for explaining processing procedures for application control which is performed when a user logs out;

FIG. 15 is a flowchart for explaining processing procedures for application control which is performed when a user logs in;

FIG. 16 is a flowchart for explaining processing procedures for application activation determination;

FIG. 17 is a flowchart for explaining processing procedures for application deactivation determination;

FIG. 18 shows an example of a user information management table; and

FIG. 19 shows an example of a user application management table.

### DESCRIPTION OF THE EMBODIMENTS

Hereinafter, best modes for carrying out the present invention will be described with reference to the drawings.

### First Embodiment

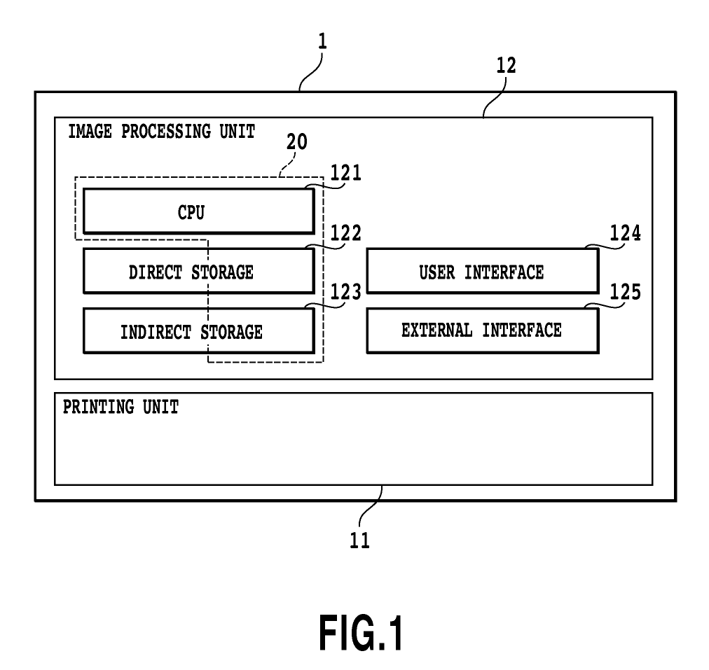

FIG. 1 is a block diagram showing a configuration of an image forming apparatus to which an application platform of the present invention is applied.

(Description of Image forming Apparatus 1)

An image forming apparatus 1 includes a printing unit 11 and an image processing unit 12.

The image processing unit 12 includes a CPU 121, a direct storage 122 (e.g., RAM), an indirect storage 123 (e.g., ROM or HDD), a user interface 124, and an external interface 125.

The direct storage 122 is a storage which exchanges data directly with the CPU 121, and the indirect storage 123 is a storage which exchanges data indirectly with the CPU 121 through the direct storage 122. The direct storage 122 stores various application and platform programs.

The user interface 124 includes a keyboard, a mouse, a display, and the like, and is capable of receiving an instruction of a user and displaying data (screen data).

The external interface 125 can receive data from external devices and transmit data to the external devices. For example, the external devices include external storage devices, such as an external HDD and an external USB memory, and separate devices, such as a host computer and an image forming apparatus which are provided separately from the image forming apparatus 1 and connected to the external interface 125 through a network.

### (Description of Platform 20)

The CPU 121 can move (store) a platform program stored in the indirect storage 123 directly to (in) the direct storage 122. Upon completion of the movement, the platform program enters the state of being executable by the CPU 121.

In this embodiment, the platform 20, indicated by broken lines in FIG. 1, includes the following three elements: the CPU 121, an area which stores the platform programs, and an area which stores information (e.g., calculation result) obtained when the CPU 121 has executed the platform programs. The area storing the platform programs is part of the direct storage 122. The other of the above-described two areas is part of the direct and indirect storages 122 and 123.

### (Description of Application Programs)

As described above, the platform 20 can move (store) a first application program stored in the indirect storage 123 to (in) the direct storage 122. Upon completion of the movement, a first application program enters the state of being executable by the platform 20. In this embodiment, this state will be referred to as a “running state” (“ran application is in a running state”).

Meanwhile, the platform 20 can delete the first application program stored in the direct storage 122 directly from the direct storage 122. Upon the deletion, the first application program enters the state of being non-executable by the platform 20. In this embodiment, this state will be referred to as a “shutdown state” (“an application is in a shutdown state”).

The platform 20 can receive data constituting the first application program through the external interface 125 and store the data in the indirect storage 123. In this embodiment, this will be expressed as follows: the first application program is “installed” on the platform 20.

Meanwhile, the platform 20 can delete the first application program stored in the indirect storage 123 (existing in the platform 20) from the indirect storage 123. In this embodiment, this will be expressed as follows: the platform 20 “uninstalls” the first application program.

It should be noted that, in the uninstallation of the first application by the platform 20, if the first application is in a running state, the platform 20 performs a deactivation process on the first application and then uninstalls this application.

While the above description has been made by using the first application program as an example, it should be apparent to those skilled in the art that the same is applied to other application programs (e.g., second and third application programs).

### (Description of Initial Screen 200)

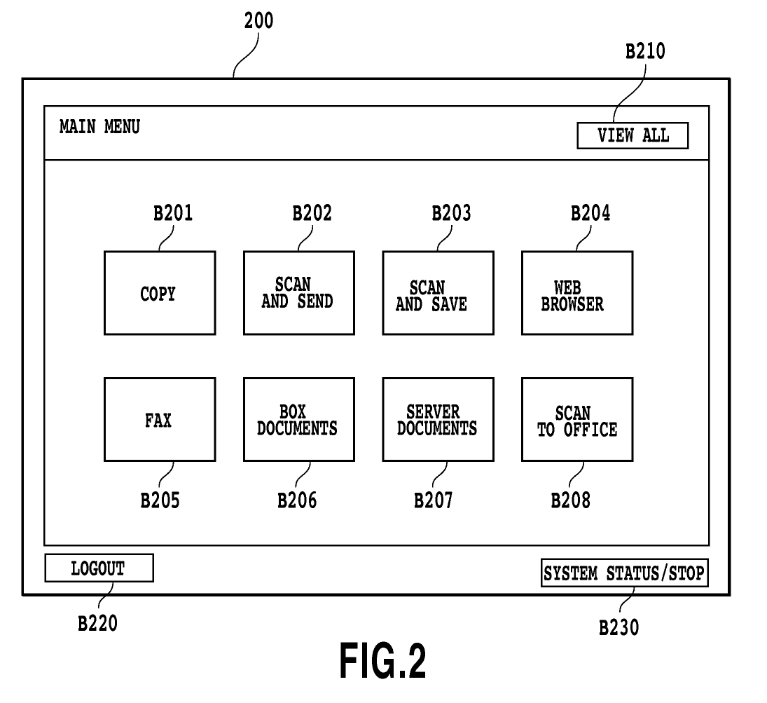

FIG. 2 shows an example of an initial screen which is displayed when a user logs into the image forming apparatus 1.

A “login” is a procedure in which a user performs predetermined operations such as the input of a user ID and a password through the user interface 124 of the image forming apparatus 1 and consequently is allowed to use the image forming apparatus 1. On the other hand, a “logout”is a procedure through which a user is not allowed to access the image forming apparatus 1 any longer, nor to use any application.

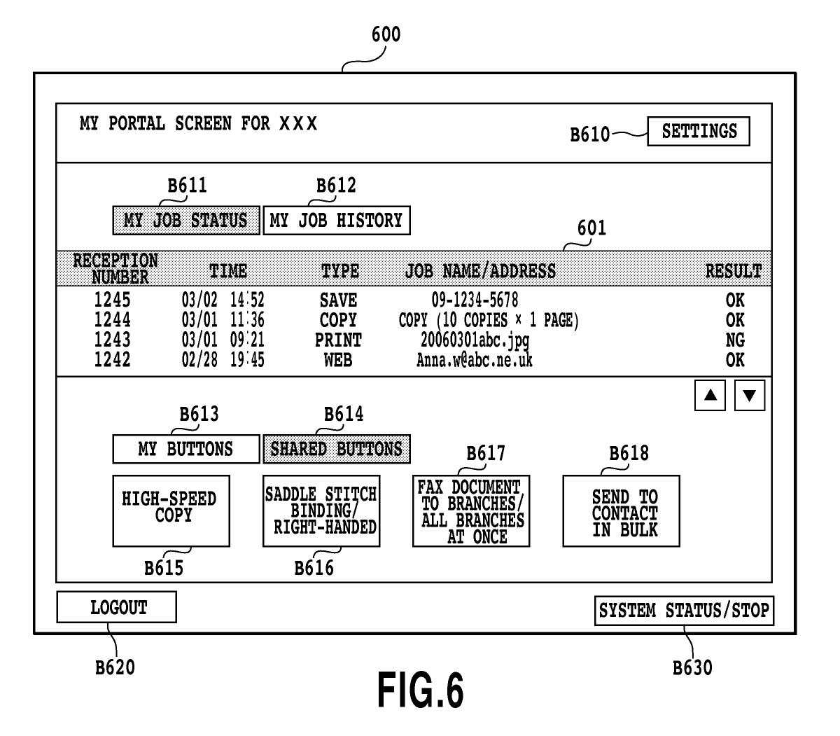

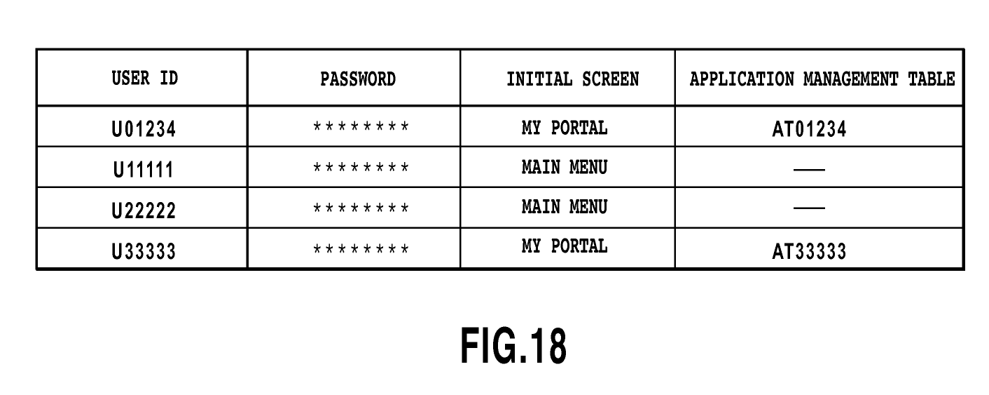

The platform 20 registers and manages information on each of users who use the image forming apparatus 1, by using a user information management table as shown in FIG. 18, for example. User information includes a user ID, a password, setting information on the initial screen which is displayed on the display of the user interface 124 at the time of a login, and an ID of an application management table which is used in an undermentioned user specific initial screen 600 (see FIG. 6). In a login procedure, the platform 20 first reads out the user information management table. Then, in accordance with the user ID and password inputted by the user through the user interface 124, the platform 20 locates the user information on the corresponding user, and displays an initial screen according to the user information on the display of the user interface 124. During the session started by the login of the user (i.e., during the period from the login time to the logout time of the user), the image forming apparatus 1 operates on the premise that any input from the user interface 124 is performed by the user.

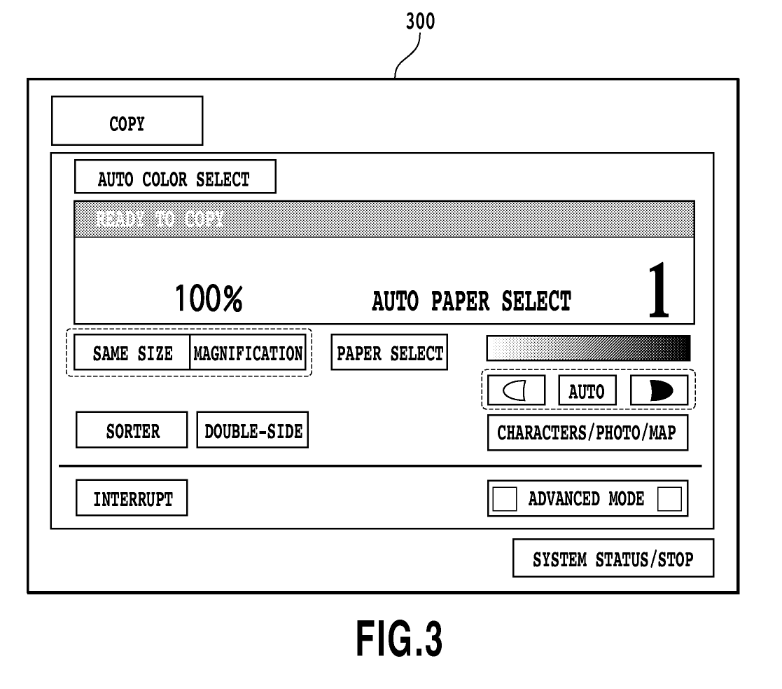

When a user logs in, the platform 20 displays a screen denoted by 200 as a login time initial screen on the display of the user interface 124. The initial screen 200 includes various buttons B201 to B208, each of which is a portal to an operational screen for operating a corresponding application (e.g., copy application A001) installed on the image forming apparatus 1. In response to an instruction given by the user through one of the buttons B201 to B208 displayed on the display of the user interface 124, the platform 20 displays the operational screen for the corresponding application on the display of the user interface 124. At this time, the platform 20 controls the screen to be displayed on the display of the user interface 124 in accordance with the undermentioned state of the application. For example, in the case where the user selects an application in the running state, the platform 20 immediately displays the operational screen (e.g., a copy screen 300 in FIG. 3, which will be described later) for this selected application on the display of the user interface 124. On the other hand, in the case where the user selects an application not in the running state, the platform 20 brings this application into the running state and, at the same time, displays a screen (not shown) for informing the user that the application is being activated.

It should be noted that a “logout” button B220 is a button for receiving a logout request from the user.

### (Description of Copy Screen 300)

FIG. 3 shows an example of a screen which is displayed on the display of the user interface 124 by the platform 20 when the platform 20 accepts an instruction of the user in the case of the copy application.

When the user presses a “COPY” button B201 on the initial screen 200 such as shown in FIG. 2, the platform 20 displays the copy screen 300 on the display of the user interface 124.

### (Description of Application State Management)

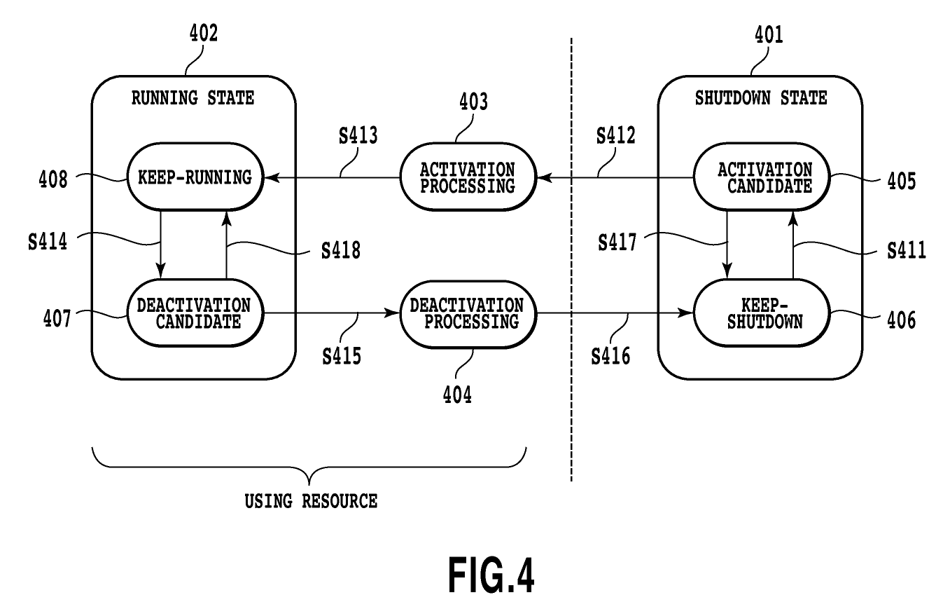

FIG. 4 is a state chart showing the transition of the state of an application. Each of arrows S411 to S418 in the drawing indicates from which state to which state the application shifts. For example, S411 indicates a shift from a keep-shutdown state 406 to a state of an activation candidate 405.

The platform 20 manages each application by broadly dividing states of the application into four states. A shutdown state 401 is a state in which the application is already deactivated, i.e., a state in which the user cannot use the application. A running state 402 is a state in which the application is already activated, i.e., a state in which the user can use the application. An activation processing state 403 is a state in which the application is shifting from the shutdown state 401 to the running state 402. In the activation processing state 403, the platform 20 performs initialization processing which includes, for example, referring to information needed to activate the application. A deactivation processing state 404 is a state in which the application is shifting from the running state 402 to the shutdown state 401. In the deactivation processing state 404, the platform 20 performs post-processing which includes, for example, writing history information on the use of the application into a predetermined file. It should be noted that the user cannot use the application in any of the activation processing state 403 and the deactivation processing state 404.

Each of the shutdown state 401 and the running state 402 is further divided into two states.

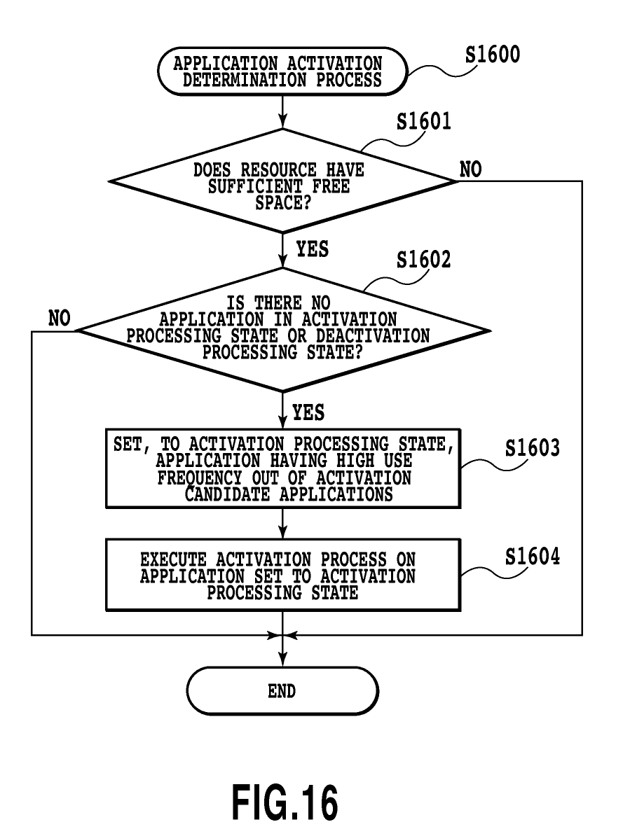

First, the shutdown state 401 is divided into the following two states: a state of an activation candidate 405 and a keep-shutdown state 406. The state of an activation candidate 405 is a state in which after receiving an instruction to activate the application, the platform 20 waits until conditions (S1601 and S1602 in FIG. 16) for activating the application are satisfied. The keep-shutdown state 406 is a state in which the platform 20 keeps the application deactivated.

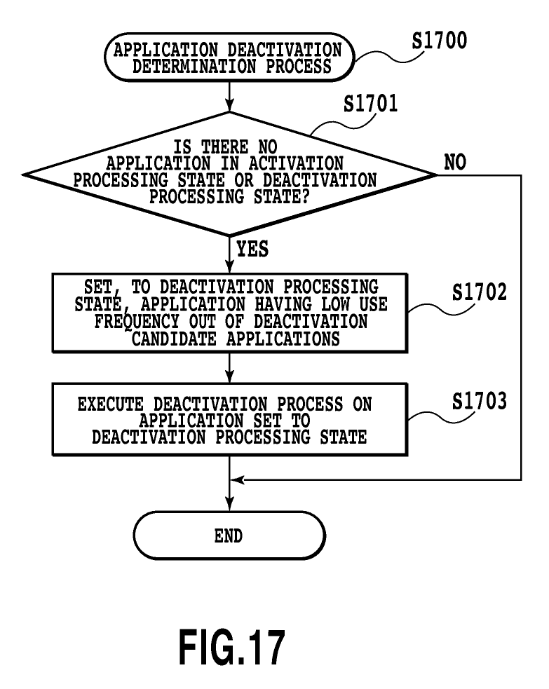

Next, the running state 402 is divided into the following two states: a keep-running state 408 and a state of a deactivation candidate 407. The keep-running state 408 is a state in which the platform 20 keeps the application activated. The state of a deactivation candidate 407 is a state in which after receiving an instruction to deactivate the application, the platform 20 waits until a condition (S1701 in FIG. 17) for deactivating the application is satisfied.

Here, while the application is in any of the running state 402, the activation processing state 403, and the deactivation processing state 404, the platform 20 is using a system resource for the application. The resource is a partial area defined in the direct storage 122 to be used by the platform 20, and is a fixed constant area which does not vary depending on the number of installed applications. The capacity of this resource is finite. Accordingly, when causing the application to shift from the shutdown state 401 to the activation processing state 403, the platform 20 checks (S1601 in FIG. 16) whether or not the resource has a sufficient free space, and then determines whether to perform the shifting. The platform 20 causes the deactivated application to wait as an activation candidate 405 before performing an activation process on the application. In other words, the platform 20 performs control to prevent a shortage of the resource, which would be caused otherwise by excessive use of the resource beyond its capacity, by not bringing the application in the keep-shutdown state 406 directly into the activation processing state 403.

An application in any of the activation processing state 403 and the deactivation processing state 404 uses a larger fraction of the CPU 121 than applications in the other states. The processing speed of the CPU 121 is limited. Accordingly, at the time of a shift between states, it is necessary to consider the status of use of the CPU 121. When the platform 20 causes the application to shift from the shutdown state 401 to the activation processing state 403 or from the running state 402 to the deactivation processing state 404, the platform 20 checks the status of use of the CPU 121 (S1602 in FIG. 16, S1701 in FIG. 17). Before causing the application in the shutdown state 401 to shift to the activation processing state 403, the platform 20 causes this application to wait as an activation candidate 405, thus preventing a decrease in the speed of processing the application which is being used by the user. Similarly, before causing the application in the running state 402 to shift to the deactivation processing state 404, the platform 20 causes this application to wait as a deactivation candidate 407, thus preventing a decrease in the speed of processing the application in the running state 402 which is being used by the user.

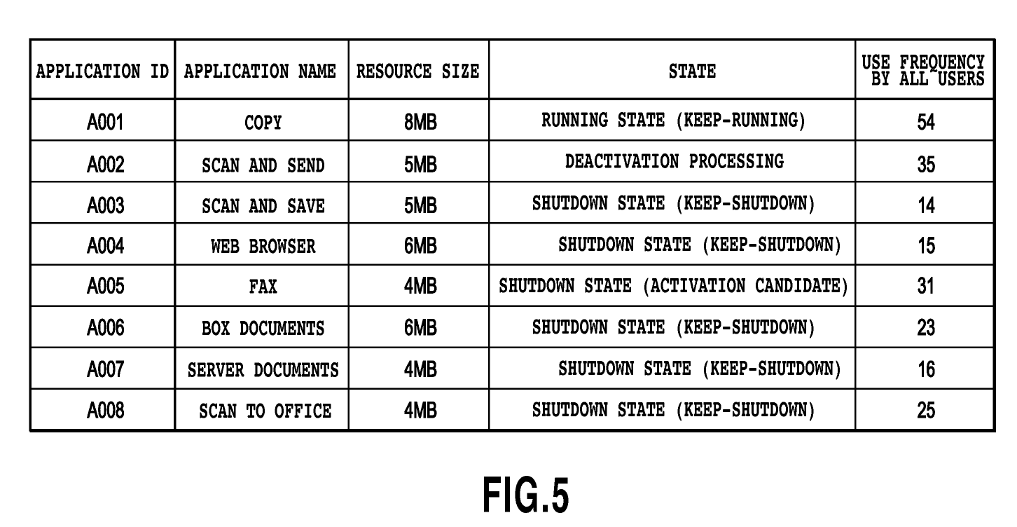

FIG. 5 shows an example of the application management table which is used by the platform 20 to manage the states of the applications. This table is referred to in undermentioned logout time application control.

The application management table includes, for each of all installed applications, information such as an “application ID,” an “application name,” a “resource size,” a “state,” and “use frequency by all users.” The “application ID” is used by the platform 20 to identify each of the installed applications. The “application name” is the name of, for example, each of the applications corresponding to the buttons B201 to B208 on the initial screen 200 in FIG. 2. The “resource size” is the resource size needed to activate the application. The “state” is the state of the application such as shown in FIG. 4, as described above. The “use frequency by all users” is the cumulative number of times that the application has been used by any of all registered users in a given past period (e.g., one week). This use frequency is regularly updated. For example, once every 24 hours, the cumulative number of times is newly counted for past one week from that day.

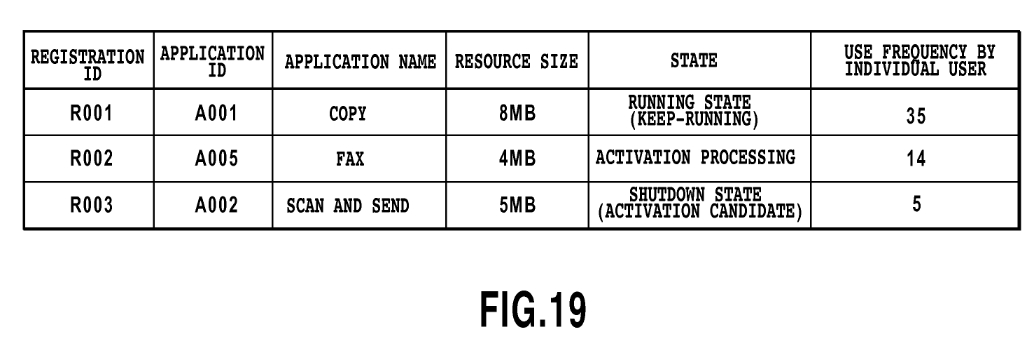

FIG. 19 shows an example of a user application management table which is used by the platform 20 to manage the states of the applications. This user application management table can be regarded as an entity of an application management table AT01234, such as described above, which corresponds to a user ID “U01234” in FIG. 18. In other words, the user application management table is an application management table for each individual user. This user application management table is referred to in undermentioned login time application control.

Using this user application management table, the platform 20 manages applications registered for each user and the states thereof. As will be described later, each user can customize which applications to register. The user application management table includes information such as a “registration ID,” an “application ID,” an “application name,” a “resource size,” a “state,” and the “use frequency by the individual user.” The “registration ID” is used to identify the time of registration and the like. The “use frequency by the individual user” is the use frequency of each application by a user, and indicates the number of times that each application has been used by the user ID “U01234” in a given past period. Accordingly, the contents of the user application management table are generally different between login users. The other elements, i.e., the “application ID,” the “application name,” the “resource size,” and the “state,” are the same as those in the application management table of FIG. 5.

### (Description of User-Specific Initial Screen 600)

FIG. 6 shows an example of an initial screen which is specific to each individual user and displayed on the display of the user interface 124 when the user logs into the image forming apparatus 1.

When the platform 20 accepts a login request from a user through the user interface 124, the platform 20 can display, as an initial screen, a user-specific screen 600 (screen different from the initial screen 200 in FIG. 2) which can be customized for each individual user. The platform 20 determines whether or not there is a registered initial screen specific to the user who is currently logged in (hereinafter referred to as the “login user”), based on user information inputted at the time of the login. If there is a registered initial screen specific to the login user, the platform 20 displays the user-specific initial screen 600 corresponding to the login user. If there is no registered initial screen specific to the login user, the platform 20 displays the default initial screen 200.

A “MY JOB STATUS” button B611 is a button for displaying the job processing status of the login user. In the illustrated example, the “MY JOB STATUS” button B611 is shaded to indicate that this button is not selected.

A “MY JOB HISTORY” button B612 is a button for displaying a job processing history of the login user. In the shown example, the “MY JOB HISTORY” button B612 is selected. Specific information on the history is displayed as a list B601.

A “MY BUTTONS” button B613 is a button for displaying buttons customizedly registered by the login user in association with routine works. In the shown example, the “MY BUTTONS” button B613 is selected, and customizedly registered buttons B615 to B618 are displayed. For example, a “FAX DOCUMENT TO BRANCHES/ALL BRANCHES AT ONCE” button B617 is a button registered by the login user so that the addresses of “all branches” will be initially selected in a screen displayed for a “FAX” application A005. The relationship of the buttons B615 to B618 to applications will be described later.

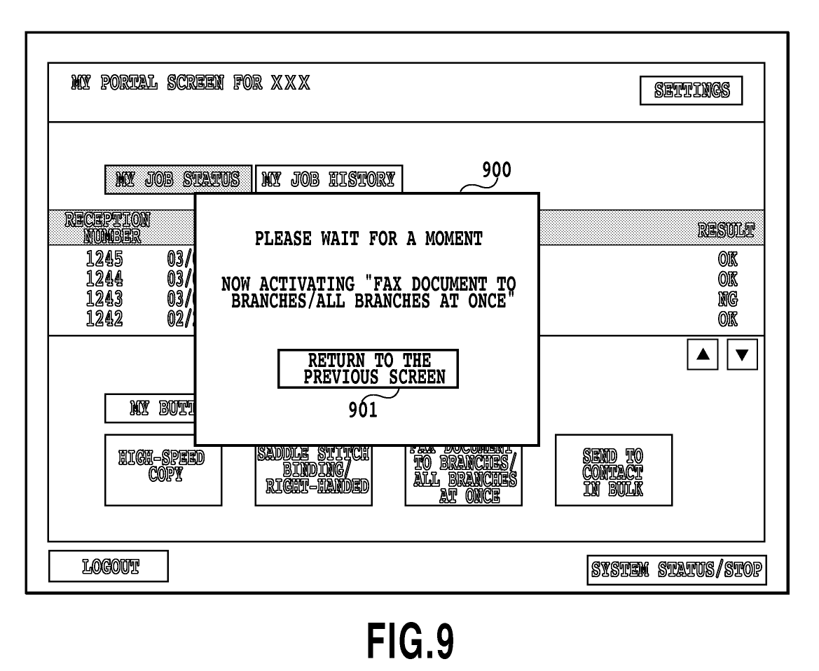

For the user-specific initial screen 600, the platform 20 also controls the screen to be displayed on the display of the user interface 124, in accordance with the aforementioned four states of the application. In the case where the user selects an application already in the running state 402 through the user interface 124, the platform 20 immediately displays an operational screen for the selected application on the display of the user interface 124. In the case where the selected application is not in the running state 402, the platform 20 displays a message screen for informing the user that the application is being activated, on the display of the user interface 124 until the application enters the running state 402. In FIG. 9, 900 denotes an example of such a message screen.

A “SHARED BUTTONS” button B614 is a button for displaying non-customized menu buttons shareable by any user. In the shown example, the “SHARED BUTTONS” button B614 is shaded to indicate that this button is not selected. Examples of these shared buttons include the buttons B201 to B208 in FIG. 2. In the case where the shared buttons have the contents of the buttons B201 to B208 in FIG. 2, when the “SHARED BUTTONS” button B614 is pressed, the platform 20 displays the buttons B201 to B208 rather than the buttons B615 to B618, in the user-specific initial screen 600.

A “SETTINGS” button B610 is a button for displaying a screen which is used to customize the user-specific initial screen 600. In the customization screen (not shown), editing, such as the addition and deletion of applications which are displayed as the “MY BUTTONS,” is mainly performed. Other than this, an application other than the applications displayed as “MY BUTTONS” can be activated for brief use. In reverse, the application currently being used can be deactivated.

For example, when the user selects a specific application in this customization screen for brief use, the platform 20 determines that the platform 20 has received, from the user, an explicit instruction to activate the selected application, and performs the following process.

First, if at the time of receiving the instruction to perform the activation from the user, the platform 20 is performing an undermentioned control process to be performed in response to a logout or a login, the platform 20 immediately terminates the control process. Then, the platform 20 sets the selected application as an activation candidate 405 of highest priority, regardless of its use frequency. Further, the platform 20 causes the selected application to wait until undermentioned conditions for activation are satisfied. In the case where a shortage of the resource will be caused, the platform 20 brings the application having the lowest use frequency of all activation candidates 405 back into the keep-shutdown state 406. If there is no application in the state of an activation candidate 405, the platform 20 causes the application having the lowest use frequency of all applications staying in the keep-running state 408 to shift to the state of a deactivation candidate 407. Immediately after the conditions for activating an application is satisfied, the platform 20 activates the application set as an activation candidate 405 of highest priority. Once the application is activated, the user can perform a desired operation (e.g., faxing in the case of the FAX application) using the application. When the task is finished, the user may immediately give the platform 20 an instruction to deactivate the application again. In this case, a process similar to the above-described one is performed. That is, the platform 20 performs a necessary process including setting the application as a deactivation candidate 407 of highest priority, and performs a deactivation process immediately after conditions for deactivation are satisfied.

As described above, in the present invention, a process based on an explicit instruction given by the user through the user interface 124 is performed preferentially over processes (activation/deactivation processes which are performed in consideration of use frequency and the like; these processes will be described in detail later) which are automatically performed at the time of a logout/login of the user.

It should be noted that a “LOGOUT” button B620 is a button for receiving a logout request from the user.

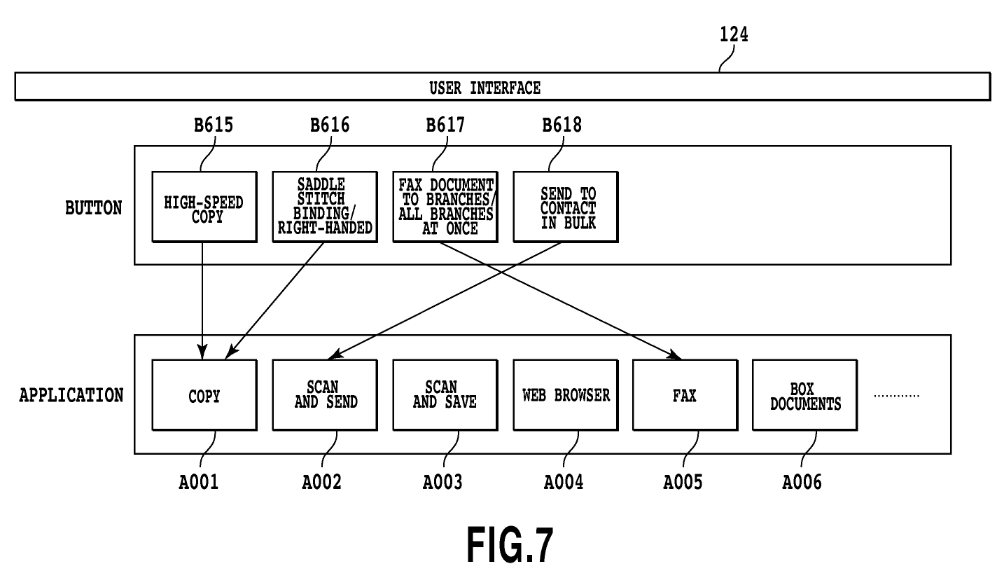

FIG. 7 shows an example of the correspondence of the buttons and the applications customizedly registered by a user.

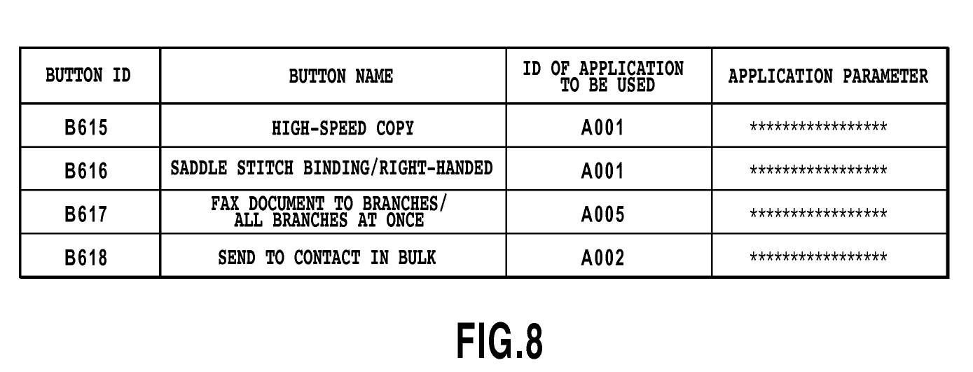

A button B615 marked “HIGH-SPEED COPY” is related to referring to “COPY” A001. A button B616 marked “SADDLE STITCH BINDING/RIGHT-HANDED” is related to referring to “COPY” AP001. A button B617 marked “FAX DOCUMENT TO BRANCHES/ALL BRANCHES AT ONCE” is related to referring to “FAX” A005. A button B618 marked “SEND TO CONTACT IN BULK” is related to referring to “SCAN AND SEND” A002. For example, when the user selects the button B617 marked “FAX DOCUMENT TO BRANCHES/ALL BRANCHES AT ONCE,” the platform 20 displays, on the display of the user interface 124, the initial screen of the “FAX” application A005 related to the button B617. The platform 20 causes settings according to a registered application parameter (see FIG. 8) of B617 to be reflected in the initial screen of A005.

FIG. 8 shows a customized button management table for managing the correspondence of customizedly registered buttons and applications for a user.

The customized button management table is created and saved for each user. At the time of a login of a user, the platform 20 finds out the customized button management table of the login user in a predetermined memory area (e.g., HDD), and reads out information in the table. The platform 20 manages the customizedly registered buttons by relating these buttons to item names such as “button ID,” “button name,” “ID of application to be used,” and “application parameter.”

### (Description of Application State Display)

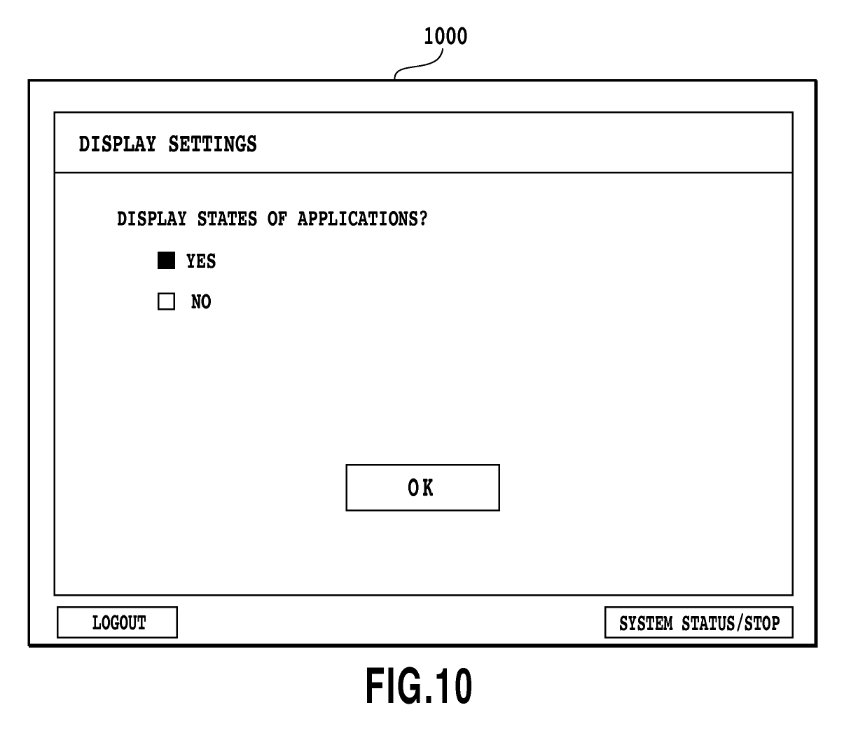

FIG. 10 shows an example of a screen which is used by a user to give an instruction to switch display settings.

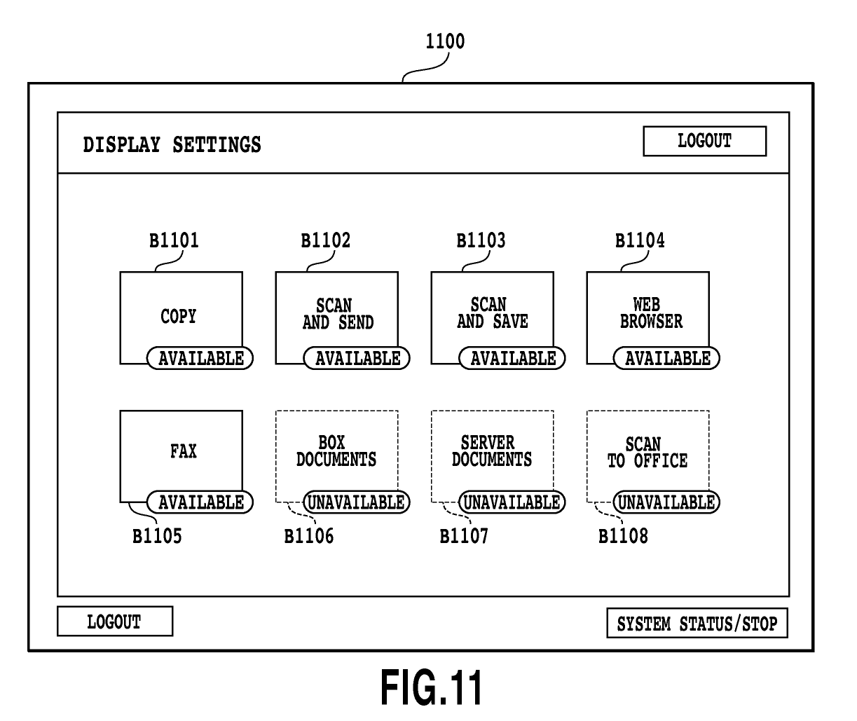

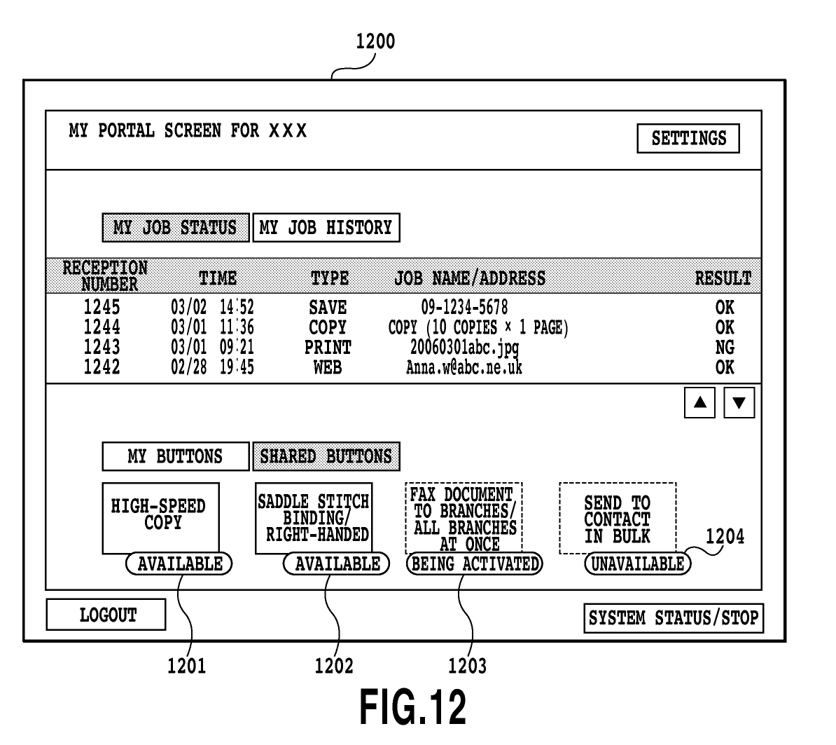

In this example, whether to “display the states of applications” can be selected on a display setting screen 1000. When the user selects “YES,” the platform 20 displays the states of the applications on the respective buttons on the initial screen 200 or the user-specific initial screen 600, the buttons indicating the applications. Each of FIGS. 11 and 12 shows an example of the case where these states are displayed. The initial screen 200 and the user-specific initial screen 600 are switched to the screens shown in FIGS. 11 and 12, respectively. If the user selects “NO” as to whether to “display the states of applications,” the platform 20 displays the initial screen 200 or the user specific initial screen 600 without change.

In FIGS. 11 and 12, an application in the running state 402 is marked “available,” which indicates that the user can immediately use the application (buttons B1101 to B1105 in FIG. 11; buttons 1201 and 1202 in FIG. 12). An application in the shutdown state 401 is marked “unavailable,” which indicates that the user cannot immediately use the application (buttons B1106 to B1108 in FIG. 11; button 1204 in FIG. 12). An application in the activation processing state 403 is marked “in activation processing,” which indicates that an activation process is currently being performed (button 1203 in FIG. 12). A button corresponding to an application in the deactivation processing state 404 is marked “in deactivation processing,” which indicates that a deactivation process is currently being performed (not illustrated). Further, a button corresponding to an application in a state other than the running state 402 are displayed by broken lines, which indicate being invalid (buttons B1106 to B1108 in FIG. 11; buttons B1203 and B1204 in FIG. 12). It should be noted that the indication of being invalid may not be displayed by broken lines. Various ways can be considered. For example, characters or frames may be displayed in a faint color or shaded so that invalid buttons will be less visible than valid buttons.

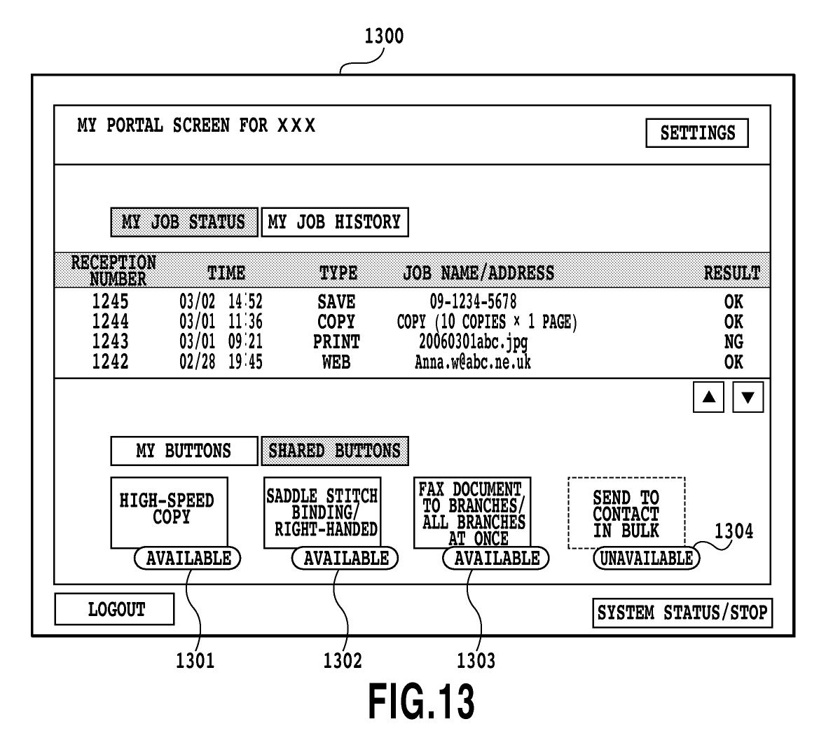

FIG. 13 shows an example of the user-specific initial screen displayed when the “fax document to branches/all branches at once” application, which has been in the activation processing state 403 and indicated by broken lines in FIG. 12, has finished being activated and has entered the running state 402. The portion marked “in activation processing” in FIG. 12 is changed to that marked “available” in FIG. 13.

### (Logout Time Application Control)

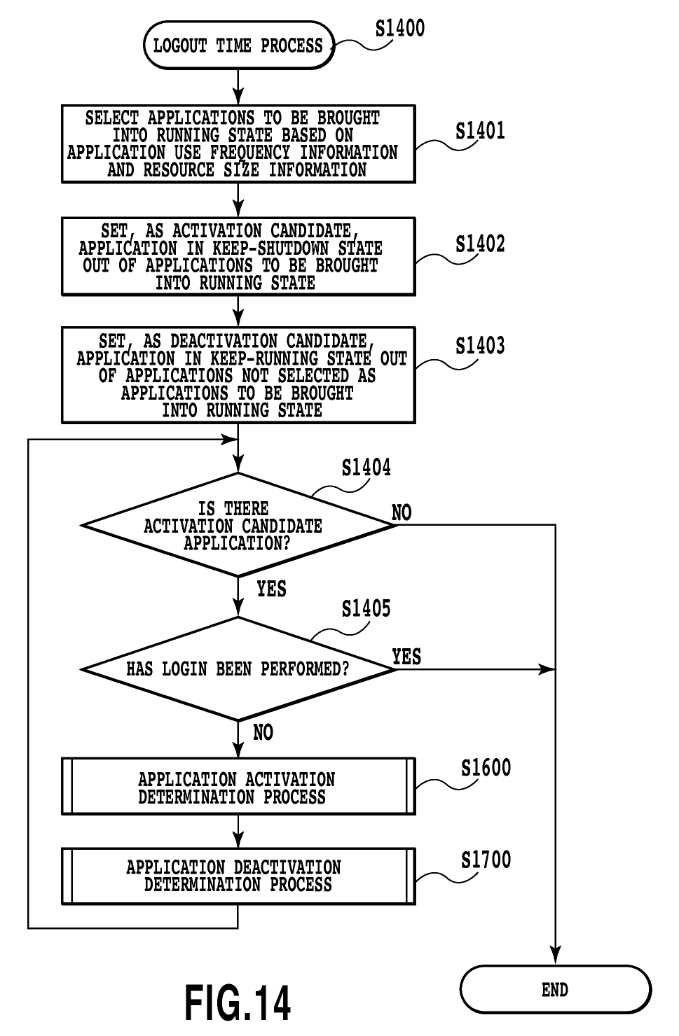

FIG. 14 is a flowchart for explaining processing procedures for application control which is performed by the platform 20 when a user logs out.

First, the platform 20 refers to the application management table of FIG. 5 and, based on use frequency information and resource size information, selects applications to be brought into the running state 402 (S1401). “Use Frequency” in FIG. 5 is the cumulative number of times that each application has been used by all registered users including the login user. Applications having higher use frequency at this time are more likely to be used at the next login. Thus, applications are selected in descending order of use frequency so that the number of selected applications will be a maximum within the range in which the total size of the resource sizes of the selected applications does not exceeds a system resource margin (RSM).

That is, applications are selected on the basis of use frequency, and the resource sizes thereof are added together; when the remaining resource (RSM—the total size) is less than the resource size of the application selected next, an application having the next highest use frequency is selected in order. Thus, applications are selected so that the total size of the resource sizes thereof will be a maximum within the range in which the following relationship is satisfied:

Total Size of Resource Sizes<RSM

Hereinafter, a specific example will be described. The resource sizes of the installed applications are assumed to be those in FIG. 5, and the system resource margin RSM is assumed to be 20 MB.

First, the application A001 having the highest use frequency is selected. Then, the application A002 having the second highest use frequency is selected. At this stage, the resource size of A002, 5 MB, is added to the resource size of A001, 8 MB, whereby the total size of the resource sizes becomes 13 MB. Further, the application A005 having the third highest use frequency is selected, and the resource size thereof, 4 MB, is added to the total size. At this stage, the total size of the resource sizes is 17 MB. An application having the next highest use frequency is an application A008. However, the resource size thereof is 4 MB, and the total size will exceed 20 MB. Therefore, this application cannot be selected. Moreover, since the resource size of the application A006 is 6 MB, which is the use frequency highest next to that of the application A008, the application A006 cannot be selected either. After all, since all the remaining applications have resource sizes not less than 4 MB, no more applications can be selected. Accordingly, the platform 20 determines the applications A001, A002, and A005 to be applications to be brought into the running state 402. When viewed from the opposite side, this is also the work of determining applications having low use frequency by all users to be applications to be brought into the shutdown state 401.

Next, the platform 20 sets, to the state of an activation candidate 405, applications currently in the keep-shutdown state 406 of all the application determined in S1401 to be applications to be brought into the running state 402 (51402). This activation candidate setting process makes it possible to activate applications likely to be used by a user who will log in next, with reference to the status of use of the resource. In this activation candidate setting process, in the case where the number of installed applications is small and the capacity of the resource is sufficient, all applications in states other than the running state 402 are set to the state of an activation candidate 405 even though the use frequencies thereof are low.

Moreover, the platform 20 sets, to the state of a deactivation candidate 407, applications currently in the keep-running state 408 of all the applications which have not been selected in S1401 as applications to be brought into the running state 402 (S1403).

Then, the platform 20 determines whether or not there is an application currently in the state of an activation candidate 405 (S1404). If the platform 20 determines that there is an application currently in the state of an activation candidate 405, then the platform 20 determines whether or not a user is newly logging in (S1405). If the platform 20 determines that a login is newly being performed, the platform 20 terminates this logout time process S1400. Then, the platform 20 shifts to a login time process S1500. Determining at this stage (S1405) whether or not a login is newly being performed can prevent the following situation: in the case where user Y logs in immediately after a logout of user X, user Y cannot use the image forming apparatus 1 until an entire logout process for user X is completed. Here, this also includes a case where “user X” and “user Y” are the same, i.e., the case of a relogin by the same user.

Thus, in this embodiment, in the case where a user logs out and immediately thereafter the same or a different user logs in, needless activation and deactivation processes are not performed. Accordingly, users are not caused to wait needlessly.

If the platform 20 determines in S1405 that a login is not being performed, the platform 20 executes undermentioned application activation determination process and an undermentioned application deactivation determination process (S1600 and S1700). Upon completion of the deactivation determination process, the platform 20 returns to S1404, and repeats the processes from S1404 to S1700 until there is no more application in the state of an activation candidate 405.

Incidentally, a user who has logged out may possibly relog in soon, as described above. For this reason, the process of S1401 may be started after waiting a predetermined period (e.g., ten seconds), rather than started immediately after the logout. This enables the user to use a necessary application soon again.

### (Login Time Application Control)

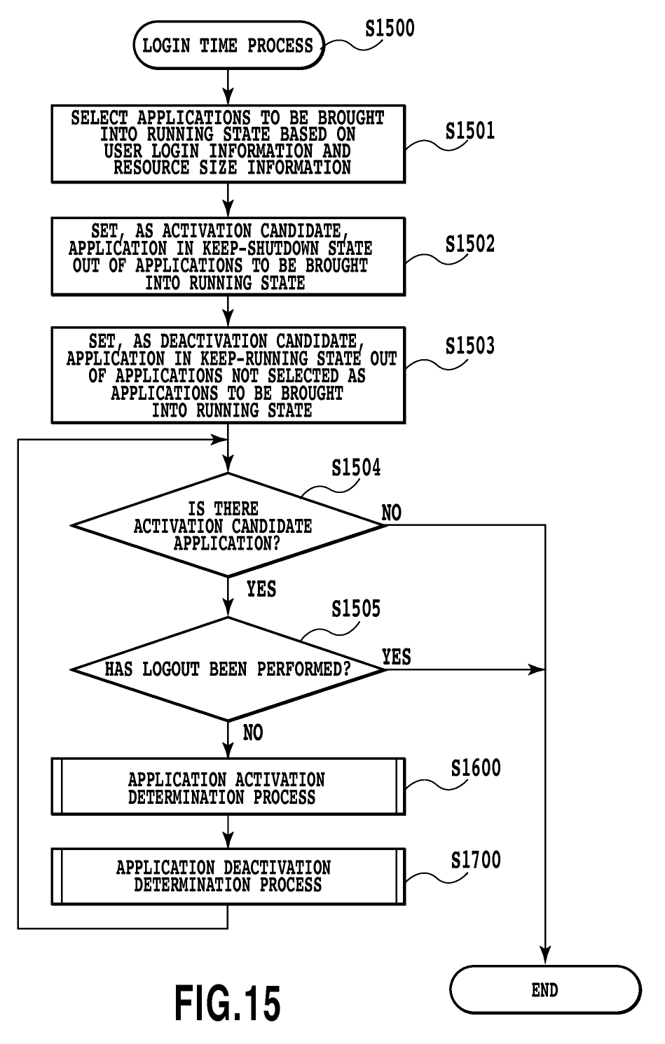

FIG. 15 is a flowchart for explaining processing procedures for application control which is performed by the platform 20 when a user logs in.

First, the platform 20 refers to the user application management table of FIG. 19 and, based on user login information and resource size information, selects specific applications to be brought into the running state 402 (S1501). The user login information includes information (see FIG. 6) on the buttons B615 to B618 registered as “MY BUTTONS,” and information (see FIGS. 7 and 8) on the applications related to these buttons. The applications registered in the user login information are applications registered for the user's own use by the login user who is currently performing the login. Applications to be brought into the running state 402 are applications determined by selecting applications in descending order of use frequency so that the number of selected applications will be a maximum within the range in which the total size of the resource sizes of all the selected applications does not exceed the system resource margin (RSM) It should be noted that the “use frequency” in this case is the use frequency obtained by counting the number of times that each application has been used by the individual user, as described in the description of FIG. 19. Accordingly, in this case, applications having low use frequency are applications unlikely to be used by the login user during the current session.

Next, the platform 20 sets, to the state of an activation candidate 405, applications currently in the keep-shutdown state 406 of all the applications selected in S1501 as applications to be brought into the running state 402 (S1502).

Further, the platform 20 sets, to the state of a deactivation candidate 407, applications which have not been selected in S1501 as applications to be brought into the running state 402 of all the applications currently in the keep-running state 408 (S1503). This deactivation candidate setting process makes it possible to deactivate applications unlikely to be used by the login user during the current session, in consideration of the status of use of the resource.

Then, the platform 20 determines whether or not there is an application currently in the state of an activation candidate 405 (S1504). If the platform 20 determines that there is an application currently in the state of an activation candidate 405, then the platform 20 determines whether or not a user is newly logging out (S1505). If the platform 20 determines that a logout is newly being performed, the platform 20 terminates this login time process S1500. Then, the platform 20 shifts to the logout time process S1400. Determining at this stage (S1505) whether or not a logout is newly being performed makes it possible to immediately suspend a needless activation or deactivation process in such a case where a user logs in and immediately thereafter logs out. Further, owing to this, when a user logs out in order to allow another user to use the image forming apparatus 1, the allowed user can immediately use the image forming apparatus 1.

If the platform 20 determines in S1505 that a logout is not being performed, the platform 20 executes the undermentioned application activation determination process and the undermentioned application deactivation determination process (S1600 and S1700). Upon completion of the deactivation determination process, the platform 20 returns to S1504, and repeats the processes from S1504 to S1700 until there is no more application in the state of an activation candidate 405.

### (Application Activation Determination Process)

FIG. 16 is a flowchart for explaining processing procedures for the application activation determination which is performed by the platform 20.

First, the platform 20 determines whether or not the resource has a free space needed to activate an application, which is a first condition for activating an application (S1601) Whether or not the resource has a free space is determined based on, for example, whether or not the resource has a free space sufficient for the resource size of the application requiring the largest fraction of the resource of all the installed applications. This ensures that a shortage of the resource is not caused. If the platform 20 determines that the resource has a free space needed to activate the determination target application, the platform 20 proceeds to S1602.

In S1602, the platform 20 determines whether or not there is no application currently in the activation processing state 403 or the deactivation processing state 404, which is a second condition for activating an application. This determination makes it possible to prevent multiple applications from concurrently entering any of the activation processing state 403 and the deactivation processing state 404, thus avoiding an excessive increase in the load on the CPU 121. This in turn prevents the speed of processing the application being used by the user from decreasing. It should be noted that the determination in S1602 may be substituted by a determination as to whether or not the load (area of use) on the CPU 121 is not more than a predetermined value, which can be set as needed.

If the platform 20 determines in S1602 that there is no application in any of the activation processing state 403 and the deactivation processing state 404, the platform 20 sets, to the activation processing state 403, only one application having the highest use frequency of all the applications in the state of an activation candidate 405 (S1603). That is, even in the case where there are two or more applications in the state of an activation candidate 405, only one application is activated, and the other applications in the state of an activation candidate 405 are not activated concurrently.

Then, in S1604, the platform 20 executes an activation process on the application set to the activation processing state 403, and then terminates the application activation determination process.

In the case where any of the first and second conditions for activating an application is not satisfied, the platform 20 terminates the application activation determination process. That is, in the case where the resource does not have a free space needed to activate the determination target application (S1601), or in the case where there is an application currently in the activation processing state 403 or the deactivation processing state 404 (S1602), the platform 20 does not proceed to S1603 or S1604, and terminates the activation determination process.

Here, in the above-described S1602, only one application having the highest use frequency is set to the activation processing state 403. However, a criterion of determination is not limited to use frequency. Instead of use frequency, a determination can be made based on, for example, the total amount of activation time. One application having the longest activation time may be set to the activation processing state 403. Moreover, the number of applications to be set to the activation processing state 403 may be two or more as long as the number is not more than a predetermined number which is set in consideration of the load rate on the CPU 121. In the case where the number of applications to be set to the activation processing state 403 is increased, the size of a free space of the resource which is regarded as being sufficient in S1601 also needs to be changed in accordance with the number of applications to be set to the activation processing state 403. For example, in the case where the number of applications to be set to the activation processing state 403 is two, it is desirable that the size of a necessary free space of the resource also be increased to twice the resource size of the application requiring the largest resource size. In this case, in S1602, a determination is made as to whether or not the number of applications in any of the activation processing state 403 and the deactivation processing state 404 is not more than a predetermined number.

Further, the number of applications to be set to the activation processing state 403 may be set by selecting applications in descending order of use frequency so that the number of selected applications will be a maximum within the range in which the total resource size of all the selected applications does not exceed a given resource size. For example, in the case where the application having the highest use frequency of all the activation candidates 405 has a so small resource size that the sum of the resource size thereof and the resource size of the application having the second highest use frequency will not exceed a given resource size, both of these applications may be set to the activation processing state 403. In this case, the size of a free space of the resource which is regarded as being sufficient in S1601 is a given resource size set as needed, and other applications in any of the activation processing state 403 and the deactivation processing state 404 are allowed to exist as long as the sum of the resource sizes thereof does not exceed the given resource size. Accordingly, a determination in S1602 is unnecessary.

### (Application Deactivation Determination Process)

FIG. 17 is a flowchart for explaining processing procedures for application deactivation determination which is performed by the platform 20.

First, the platform 20 determines whether or not there is no application currently in the activation processing state 403 or the deactivation processing state 404, which is a condition for deactivating an application (S1701). This determination makes it possible to prevent multiple applications from concurrently entering any of the activation processing state 403 and the deactivation processing state 404, thus avoiding an excessive increase in the load on the CPU 121. This in turn prevents the speed of processing the application being used by the user from decreasing. It should be noted that the determination in S1701 maybe substituted by a determination as to whether or not the load (area of use) on the CPU 121 is not more than a predetermined value.

If the platform 20 determines in S1701 that there is no application in the activation processing state 403 or the deactivation processing state 404, the platform 20 sets, to the deactivation processing state 404, only one application having the lowest use frequency of all the applications in the state of a deactivation candidate 407 (S1702).

Then, the platform 20 executes (S1703) a deactivation process on the application set to the deactivation processing state 404 in S1702, and then terminates the application deactivation determination process.

In the case where the above-described condition for deactivating an application is not satisfied, i.e., in the case where there is an application in any of the activation processing state 403 and the deactivation processing state 404 (S1701), the platform 20 terminates the application deactivation determination process.

Here, in S1702, only one application having the lowest use frequency is set to the deactivation processing state 404. However, a criterion of determination is not limited to use frequency. Instead of use frequency, a determination can be made based on, for example, the total amount of activation time. One application having the shortest activation time may be set to the deactivation processing state 404. Moreover, the number of applications to be set to the deactivation processing state 404 may be two or more as long as the number is not more than a predetermined number which is set in consideration of the load rate on the CPU 121. In this case, in S1701, a determination is made as to whether or not the number of applications in any of the activation processing state 403 and the deactivation processing state 404 is not more than a predetermined number.

Further, the number of applications to be set to the deactivation processing state 404 may be set by selecting applications in ascending order of use frequency so that the number of selected applications will be a maximum within the range in which the total resource size of all the selected applications does not exceed a given resource size. For example, in the case where the application having the lowest use frequency of all the deactivation candidates 407 has a so small resource size that the sum of the resource size thereof and the resource size of the application having the second lowest use frequency will not exceed a given resource size, both of these applications may be set to the deactivation processing state 404. In this case, in S1701, a determination is made as to whether or not the sum of the total resource size of the applications currently in any of the activation processing state 403 and the deactivation processing state 404 and the resource size of the application to be deactivated is not more than a given resource size set as needed.

### Other Embodiments

It should be noted that in the present invention, a software program (program corresponding to the flowcharts shown in the drawings in the above-described embodiment) which implements functions of the above-described embodiment is directly or remotely supplied to a system or device. Further, the present invention also includes the case where a computer of the system or device reads out and executes the code of the supplied program and thus implements functions of the above-described embodiment.

Accordingly, program code itself which is installed on the computer in order to implement functions and processes of the present invention by the computer also implements the present invention. In other words, the present invention includes a computer program itself for implementing functions and processes of the present invention.

In this case, the program may be in any form, including object code, a program which is executed by an interpreter, and script data which is supplied to an OS, and the like, as long as they have the function of the program.

Recording media for supplying the program include, for example, a floppy (trademark) disk, a hard disk, and an optical disk. Further, recording media also include a magneto-optical disk, an MO, a CD-ROM, a CD-R, a CD-RW, a magnetic tape, a nonvolatile memory card, a ROM, a DVD (DVD-ROM, DVD-R), and the like.

Other than the above, the program may be supplied through a connection, established by a browser on a client computer, to a web site. In this case, the computer program of the present invention may be downloaded as it is or as a compressed file having an automatic installation function, from the connected web site to a recording medium such as a hard disk. Further, the present invention can be implemented by dividing program code constituting the program of the present invention into two or more files and by respectively downloading them from different web sites. That is, the present invention also includes a WWW server which allows multiple users to download a program file or files for implementing functions and processes of the present invention on a computer.

In one embodiment, the program of the present invention is distributed to users as a recording medium, such as a CD-ROM, which contains the program in encrypted form. Then, users meeting predetermined conditions are permitted to download key information for decryption from a web site through the Internet. Further, by using the key information, the encrypted program is executed and installed on a computer. Thus, functions and processes of the present invention can be implemented.

In another embodiment, a computer reads out and executes a program, thus implementing the functions of the aforementioned embodiment. An OS and the like operating on the computer may partially or fully perform an actual process based on instructions of the program. This process can also implement the functions of the aforementioned embodiment.

In yet another embodiment, a program read out from a recording medium is written to a memory device provided in a function enhancement board inserted in a computer or provided in a function enhancement unit connected to a computer. Then, based on instructions of the program, a CPU and the like provided in the function enhancement board or unit partially or fully performs an actual process. This process can also implement the functions of the aforementioned embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008201997, filed Aug. 5, 2008, which is hereby incorporated by reference herein in its entirety.

What is claimed is:

1. An application platform on which a plurality of applications operate, comprising:
a user interface configured to receive an instruction of a user;
an application selecting component configured to select one or more applications to be brought into a running state, at a time of a logout of the user instructed through the user interface;
an activation candidate setting component configured to set, as an activation candidate, an application in a shutdown state out of the applications selected by the application selecting component;
an activation process component configured to activate an application; and
a controller configured to cause, at the time of the logout, the activation process component to activate the application set as the activation candidate by the activation candidate setting component.

2. The application platform according to claim 1, further comprising:
a deactivation candidate setting component configured to set, as a deactivation candidate, an application in the running state out of the applications not selected by the application selecting component; and
a deactivation process component configured to deactivate an application,
wherein the controller causes the deactivation process component to deactivate the application set as the deactivation candidate by the deactivation candidate setting component.

3. The application platform according to claim 2, further comprising:
a user registration component configured to register a user; and
a component configured to accumulate, for each application, use frequency at which the application is used by all users registered by the user registration component,
wherein the application selecting component selects the one or more applications to be brought into the running state, in descending order of the use frequency at the time of the logout of the user.

4. The application platform according to claim 3, wherein the application selecting component waits for a predetermined period of time after the user logs out, and then selects the one or more applications to be brought into the running state.

5. The application platform according to claim 4, wherein
the controller determines whether or not the application set as the activation candidate is activatable, and,
if the controller determines that the application set as the activation candidate is activatable, the controller causes the activation process component to activate the application set as the activation candidate.

6. The application platform according to claim 4, wherein the controller limits the number of applications which is activated by the activation process component to a predetermined number or less.

7. The application platform according to claim 4, wherein the controller causes a process of a specific application instructed by the user through the user interface to be performed preferentially over execution of the activation process and/or the deactivation process at the time of the logout.

8. The application platform according to claim 4, further comprising a component configured to determine whether or not a user newly logs in, after the application selecting component selects the one or more applications to be brought into the running state,
wherein if the component configured to determine whether or not a user newly logs in determines that a user newly logs in, the controller cancels the activation process and deactivation process which are performed at the time of the logout.

9. An application platform on which a plurality of applications operate, comprising:
a user interface configured to receive an instruction of a user;
an application selecting component configured to select one or more applications to be brought into a running state, at a time of a login of the user through the user interface;
a deactivation candidate setting component configured to set, as a deactivation candidate, an application in the running state out of the applications not selected by the application selecting component;
a deactivation process component configured to perform a deactivation process on an application; and
a controller configured to cause, at the time of the login, the deactivation process component to perform the deactivation process on the application set as the deactivation candidate by the deactivation candidate setting component.

10. A method of managing an application platform on which a plurality of applications operate, the method comprising the steps of:
receiving an instruction of a user through a user interface;
selecting one or more applications at a time of a logout of the user instructed through the user interface, the one or more applications to be brought into a running state;
setting, as an activation candidate, an application in a shutdown state out of the applications selected in the application selecting step;
activating an application; and
controlling to cause an activating the application in the activating step, at the time of the logout, the application set as the activation candidate in the activation candidate setting step.

11. The method according to claim 10, further comprising the steps of:
setting, as a deactivation candidate, an application in the running state out of the applications not selected in the application selecting step; and
deactivating an application,
wherein the control step includes causing the deactivating the application in the deactivation step, the application set as the deactivation candidate in the deactivation candidate setting step.

12. The method according to claim 11, further comprising the steps of:
registering a user; and
accumulating, for each application, use frequency at which the application is used by all registered users,
wherein the application selecting step includes selecting the one or more applications to be brought into the running state, in descending order of the use frequency at the time of the logout of the user.

13. The method according to claim 12, wherein the application selecting step waits for a predetermined period of time after the user logs out, and then selects the one or more applications to be brought into the running state.

14. The method according to claim 13, wherein
the control step includes:
determining whether or not the application set as the activation candidate is activatable, and,
if it is determined that the application set as the activation candidate is activatable, in the activation processing step, control to cause the activating the application set as the activation candidate.

15. The method according to claim 13, wherein the control step includes limiting the number of applications which is activated by the activating step to a predetermined number or less.

16. The method according to claim 13, wherein the control step includes causing a process of a specific application instructed by the user through the user interface to be performed preferentially over execution of the activation process and/or the deactivation process at the time of the logout.

17. The method according to claim 13, further comprising the step of determining whether or not a user newly logs in, after the one or more applications to be brought into the running state are selected in the application selecting step,
wherein if it is determined that the user newly logs in in the determining step, the activating step and deactivating step which are performed at the time of the logout is cancelled.

18. A method of managing an application platform on which a plurality of applications operate, the method comprising the steps of:
receiving an instruction of a user through a user interface;
selecting one or more applications to be brought into a running state, at a time of a login of the user through the user interface;
setting, as a deactivation candidate, an application in the running state out of the applications not selected in the application selecting step;
deactivating an application; and
controlling to cause a deactivating the application in the deactivating step, at the time of the login, the application set as the deactivation candidate in the deactivation candidate setting step.
